(19) United States
(12) Patent Application Publication
(10) Pub. No.: US 2007/0007066 A1
(43) Pub. Date: Jan. 11, 2007

(54) Peak load detection determination for deploying load limiting restraint devices

(75) Inventor: Eric G. Mertz, Rochester, MI (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 11/474,812

(22) Filed: Jun. 26, 2006

Related U.S. Application Data
(60) Provisional application No. 60/698,206, filed on Jul. 8, 2005.

(51) Int. Cl. B60R 21/00; E05F 15/00; B60K 28/14

(52) U.S. Cl. 180/268; 701/45; 280/806; 180/282

(57) ABSTRACT

A method of operating a load limiting restraint system including the steps of receiving an acceleration value and also receiving a signal indicative of an occupant size. The signal received of occupant size is combined with the acceleration value to predict a load on the occupant and the restraint system. If the predicted load exceeds a predicted load value then the load limiting device is actuated to gradually reduce and selectively release the seatbelt.

### CROSS REFERENCE TO RELATED APPLICATION

The application claims priority to U.S. Provisional Application No. 60/698,206 which was filed on Jul. 8, 2005.

### BACKGROUND OF THE INVENTION

This invention generally relates to a method and system for determining whether or not to deploy restraint system devices. More particularly, this invention relates to a method and system for predicting loads utilized for deploying restraint system devices.

Motor vehicles are typically equipped with seat belts to restrain an occupant during a collision. Typically, the seat belt is tensioned to maintain a desired fit on an occupant. Slow easy motion of the seat belt is provided to allow movement of the belt during normal conditions. However during a collision event, the seat belt is locked to hold the occupant in place within the seat. Complete locking of the seat belt can itself cause injury to an occupant and therefore seat belts are designed to extend with the occupant to lessen the impact with the seat belt.

Load limiting of the seat belt during a crash event initially locks the seat belt and then controls the release of the belt to allow controlled forward movement that slowly decelerates the occupant until stopped. Controlling the load placed on the belt requires information about the severity of the collision and physical characteristics of an occupant. Currently information on the severity of the collision relative to the occupant is time or displacement based. A time from a detected collision event or displacement of sensor disposed in a crash zone are utilized in determining a load on the seat belt, which in turn is utilized to determine a rate at which the seat belt is released.

Disadvantageously, the use of time and displacement based data require complex calibration techniques that require excessive processor time and space. Further, there are inherent errors built in to the use of information derived from time or displacement sensed elsewhere in the vehicle. These inherent errors reduce the accuracy of the detected load and limit the performance of the restraint system.

Accordingly, it is desirable to develop a system and method for predicting loads experienced by an occupant during a crash event that utilized less processor time and that simplifies the overall process.

### SUMMARY OF THE INVENTION

An example method and system for operating and determining when to deploy a load limiting device for a restraint system includes the steps of detecting an acceleration value. The detected acceleration value is combined with information indicative of occupant size to predict a load on the restraint system. A prediction of the load on the restraint system is then compared with a desired threshold value to determine actuation characteristics of the load limiting device such that the seatbelt is gradually released to secure an occupant during a crash event.

The example method and system utilizes longitudinal acceleration and information indicative of occupant size to predict a load on an occupant. This prediction and information is provided to the load limiting device to appropriately control the restraint system. The restraint system locks the seatbelt restraints in response to a detected crash event and then gradually releases the belts to limit the load incurred by the occupant.

The load limiting system requires information that is indicative of the load exerted on the occupant. As occupants vary in size so will the load on the belt and operation of the load limiting device. A larger occupant will exert a larger load on the belt restraint than a smaller operator. It is for this reason that the example load limiting method provides information to allow the load limiting device to be released in a desired manner dependent on the size of the occupant.

The example method includes the step of receiving an acceleration signal. The acceleration signal is determined and measured against a peak value and a threshold value. The peak value and threshold value are included for a plurality of occupant sizes or categories. Each of these sizes or categories includes a different threshold and peak value that will provide a trigger for the load limiting algorithm to operate.

Receipt of the acceleration value is fed through various decision blocks for each of the plurality of categories included in the load limiting algorithm. Each evaluation of acceleration for each category will result in a deploy or no deploy decision. These decisions are then combined with the actual occupant size to determine if deployment of the restraint systems is required, and if so, how the seat belt will be released.

Accordingly, the method and system of this invention provides an accurate reliable means for determining the load on an occupant during a crash event.

These and other features of the present invention can be best understood from the following specification and drawings, the following of which is a brief description.

### BRIEF DESCRIPTION OF THE DRAWINGS

FIG. 1 is a schematic representation of the example system according to this invention.

FIG. 2 is a block diagram illustrating the major portions of the method according to this invention.

FIG. 3 is a block diagram illustrating the multi-load limiting deployment determination method according to this invention.

FIG. 4 is a graph illustrating peak acceleration and threshold acceleration value utilized for determining the load limits according to this invention.

### DETAILED DESCRIPTION OF THE PREFERRED EMBODIMENT

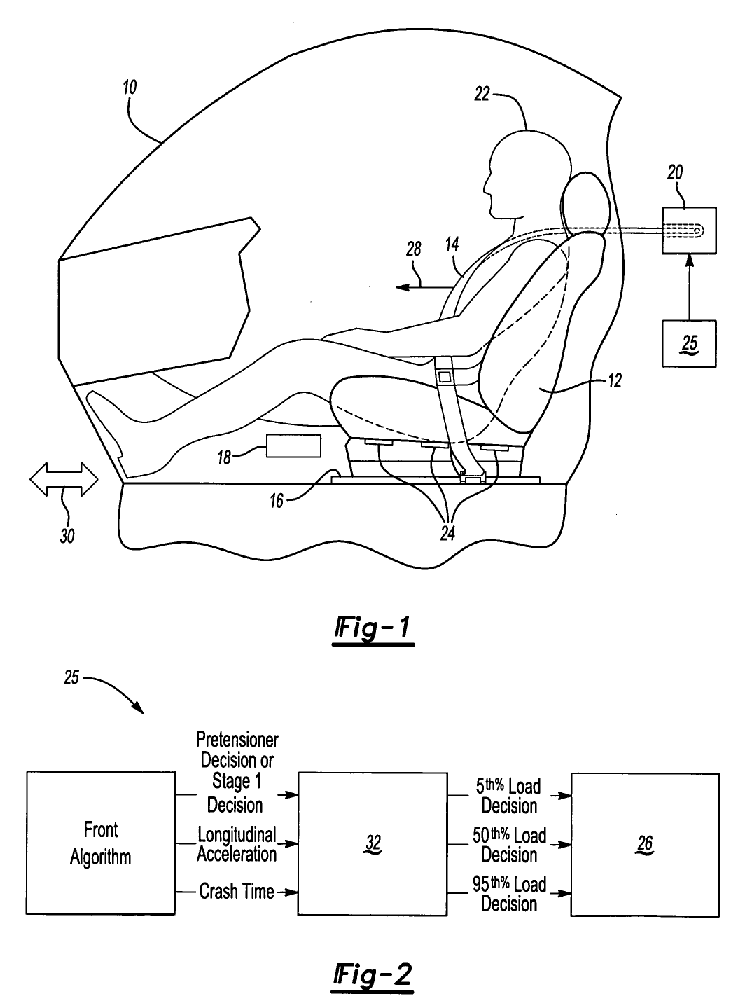

Referring to FIG. 1, a vehicle is schematically illustrated at 10 and includes a seat 12 mounted to a seat rack 16. A seatbelt 14 is attached to and releasably secured by a pretensioner system 20. The pretensioner system 20 secures the occupant 22 within the seat 12. Further, the pretensioner 20 is utilized to secure the seatbelt 14 upon the actuation or detection of an acceleration of the vehicle 10 that is indicative of a crash event. The seatbelt 14 operates by allowing movement of the occupant 22 during normal operating conditions. When a crash event is indicated by the acceleration of the vehicle 10, the pretensioner 20 locks up to securely fasten the seatbelt 14 and control movement of the occupant 22 relative to the vehicle 10 and the seat 12.

During a crash event or an extreme deceleration in the direction indicated by the arrows 30, the occupant moving forward exerts a load in the direction indicated by arrow 28 on the seatbelt 14. In some instances, the load of the operator against the belt 14 is greater than desired. For this reason, the pretensioner 20 allows the selective and gradual release of the belt 14 to lessen the load on the occupant 22.

The vehicle 10 is equipped with an acceleration sensor 18 disposed somewhere in the vehicle to sense acceleration in a longitudinal direction. Longitudinal direction is indicated by the arrows 30. The size of the occupant 22 is determined through known systems and devices such as an indication of position of the seat rack 16 relative to other portions of the vehicle. The size of the driver can be determined relatively accurately by a position of the seat as the driver must be in a certain position to control the vehicle. Accordingly, the size of the driver can be determined by the position of the seat rack 16 and provides a reasonably accurate measurement of the size of the driver occupant 22.

The position of the seat rack 16 is not a good indication of occupant size as there is no requirement for vehicle control on a passenger. For a passenger side seat, weight sensors 24 can be utilized to determine a weight of the occupant 22 that it is then utilized to determine and categorize the size of an occupant.

The pretensioner 20 operates differently for different sized occupants during impact events. The load level limiting method categorizes occupants into one of several groups. Each group pertains to occupants that are of a fifth, fiftieth and ninety-fifth percentile of the population. These numbers represent small occupants, normal or medium sized occupants and large occupants. As appreciated for each given acceleration of the vehicle 10, the load on the seatbelt 14 will be dependent on the size of the occupant. Larger occupants will exert a larger load on the seat belt 14 for lesser accelerations when compared to smaller occupants.

The disclosed example method of controlling the load limiting function of the pretensioner 20 provides for the selective actuation of the pre-tension to gradually release the seatbelt 14 in a manner determined to reduce potential injury to the occupant. The load limiting method operates the pretensioner 20 in a manner that accommodates the occupant's size and the acceleration with which the vehicle 10 is encountering.

Referring to FIG. 2, the method utilizes longitudinal acceleration, crash time and pretensioner decisions as an input into a multi-load limiting decision algorithm 32. The longitudinal acceleration is sensed from a sensor 18 disposed within a center portion of the vehicle. In the example, the sensor 18 is positioned within the passenger compartment of the vehicle. Positioning of the sensor 18 within the passenger compartment substantially removes calibration requirements and other inaccuracies resulting from a remotely located acceleration sensor 18.

The decision algorithm makes several decisions based on a plurality of categories of occupants. In the disclosed example, a fifth percentile, fiftieth percentile and ninety-fifth percentile are utilized and a separate decision made for each group. This decision is then fed to a controller 26 that operates the pretensioner 20.

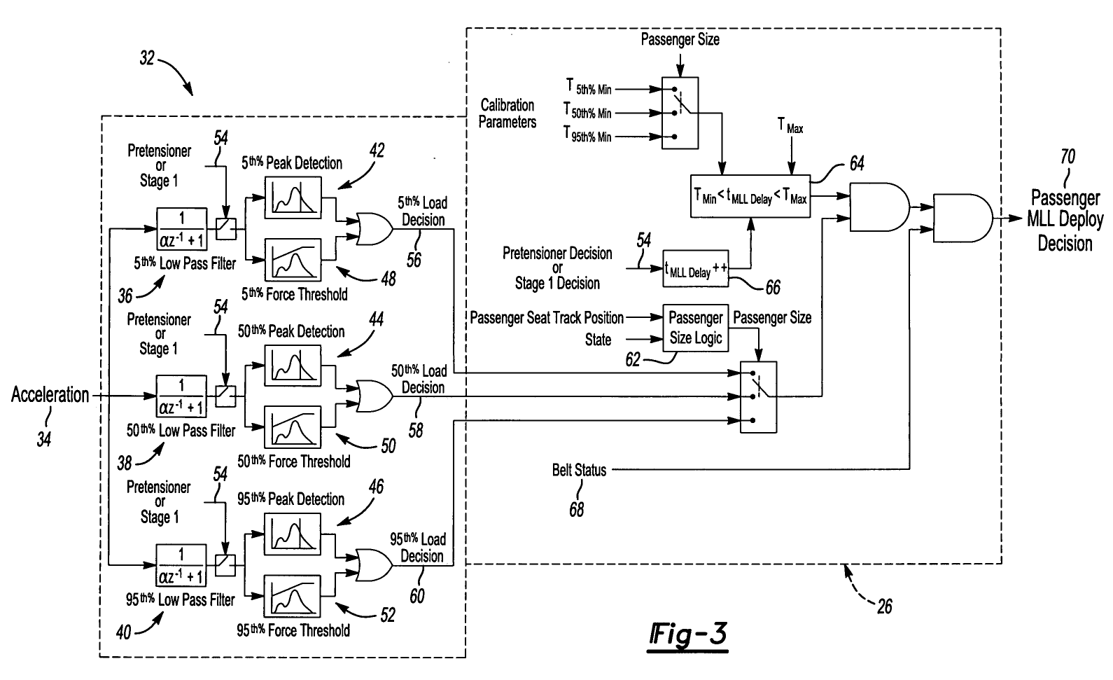

Referring to FIG. 3, the example method is illustrated in schematic block form. A load limiting decision algorithm 32 receives a signal 34 that is indicative of acceleration of the vehicle 10. This acceleration 34 is fed to three separate low pass filters 36, 38, 40. Each of the low pass filters 36, 38, 40 are utilized and set up to accommodate a specific desired category of occupant size. In the example case, the low pass filters 36 are optimized for an occupant categorized in the fifth percentile. The low pass filter 38 is optimized for occupant categorized in the fiftieth percentile and the low pass filter 40 is optimized for an occupant categorized in the ninety-fifth percentile. Acceleration data filtered through the low pass filters 36, 38, 40 is then fed to the acceleration detection and threshold modules. However, this is only done if a pretensioner or unbelted stage signal 54 is supplied and allows the acceleration data 34 to pass there through.

For each occupant category, a different acceleration value and threshold is utilized to make the determination of controlling the load limiting device. The system utilizes a predicted load for the determination and control of the pretensioner system 20. Load is a value dependent on acceleration and mass or weight of the occupant. For each of the categories of occupant size, a different acceleration results in differing loads. As appreciated, the specific load of the occupant that will trigger operation of the load limiting module is essentially constant. However, the acceleration required to reach that load is dependent on the occupant size. Accordingly, the load limiting module 32 utilizes different acceleration limits combined with differing occupant size categories to determine when the threshold load value has been exceeded.

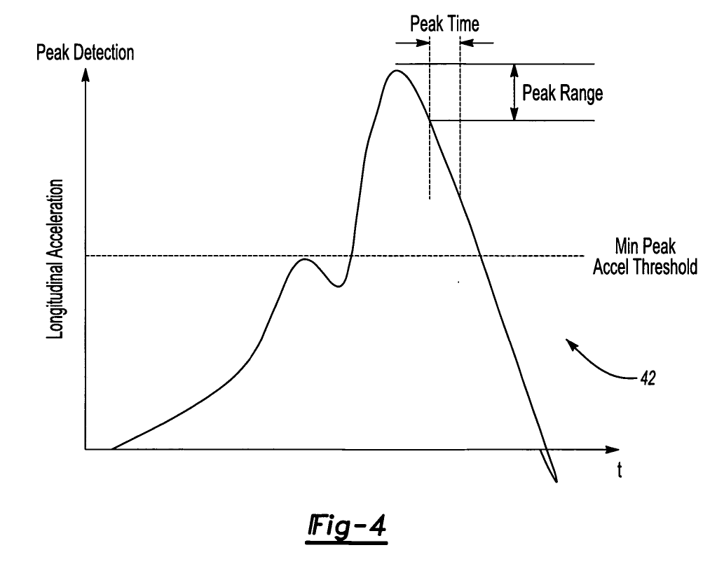

In the example module 32, the fifth percentile check includes a peak detection check 42 and a forced threshold check 48. The peak detection check is utilized for detecting severe crash events. Referring to FIG. 4, the peak detection 42 uses a minimum acceleration threshold and a delta peak along with a timer to determine an acceleration peak. As appreciated, the highest value is compared to other values within a certain time period and if that highest value is not exceeded within that time period then that value is indicated as a peak range. Peak range is checked after a minimum acceleration level is exceeded. This minimum acceleration level is continuously monitored and the difference between the current acceleration value and that of a peak range is utilized to determine whether it is utilized to predict a load on an occupant.

Referring again to FIG. 3, the example module 32 includes dual path acceleration detection and threshold values that will provide a positive load decision for actuating the load limiting device. The first is the peak detection algorithm that detects the peak acceleration based on the timed threshold within a specific given time.

This detection algorithm is repeated for each of the fiftieth percentile and ninety-fifth percentile occupant categories. Each category requires a different acceleration value that when combined with occupant size corresponds with a predicted load that prompts operation of the load limiting device. The fiftieth percentile detection includes the detection algorithm 44 and the forced threshold block 50. The ninety-fifth percentile peak check includes the peak detection block 46 and the forced threshold block 52. Each of these acceleration values feed an over block that indicates what is combined to provide a load decision.

If any of the acceleration thresholds for any of the occupant categories have been exceeded, then a positive signal for the actuation of the load limiting hardware will be provided to the controller 26. The load decisions 56, 58 and 60 are all indicative that the acceleration value has exceeded a threshold value for that occupant category that when combined with the mass corresponding to an occupant within that category will generate a load 28 of such a value as to require actuation and operation of the load limiting features of the pretensioner 20.

However, at this point the load decisions 56, 58, 60 are only an indication that the acceleration parameters have been exceeded for each of the occupant categories. This decision is then relayed to the pretensioner controller 26. The pretensioner controller combines the decisions provided by the load limiting module 32 with other parameters that are utilized in deciding whether or not to actuate the load limiting device. These parameters include a signal that indicates that the belt is actually engaged. As appreciated, a belt status signal is utilized and if the belt is not buckled or actuated then no load limiting action is required. Further, the specific size of the occupant 22 is relevant as to whether the load limiting device needs to be actuated. The load limiting module provides the information that if an occupant of a specific category is seated within the seat then the load has been exceeded.

However, the data of the actual occupant within that seat is not provided within the load limiting module 32. That data is provided in the controller module 26 by the passenger size logic module 62. The passenger size logic module 62 receives information that is indicative of a passenger seat track position or of a passenger weight provided by the weight sensors 24. These are only two example methods for determining occupant size and other methods as are know are also within the contemplation of this invention. The actual occupant size within a seat is utilized in conjunction with the decisions 56, 58, 60 utilized to determine a positive indication that the load limiting device should be actuated to control gradual release of the seatbelt 14.

For a very low force crash event, operation decisions for the ninety-fifth percentile occupant will initiate the load limiting device. This is so because an occupant of the ninety-fifth percentile will require less acceleration to exceed the threshold load value that would require operation of the load limiting device. Occupants of the ninety-fifth percentile that are larger will not exceed load threshold value at the same accelerations an occupant of the ninety-fifth percentile will. Other parameters are utilized to determine if the load limiting device should be actuated. These other parameters include the pretensioner decision or an unbelted stage decision as indicated at 54. A minimum time 64, 66 is also utilized in making a decision as to whether the multi-load limiting device should be actuated and engaged to slow and secure the occupant 22. If all these parameters meet the desired criteria then a multi-load limiting deploy decision 70 is forwarded on to the controller 26 to engage and allow and provide operation of the pretensioner 20 in a manner that will gradually release the belt 14 given a specific occupant size.

Accordingly, the load limiting decision method according to this invention provides for the predication of loads on an occupant for use in deploying load limiting modules of a seatbelt pretensioner. This is accomplished by utilizing existing sensors and information without the use of additional components.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A method of operating a load limiting restraint system comprising the steps of:
a) receiving an acceleration value;
b) receiving a signal indicative of occupant size;
c) predicting a load restraint system based on the received acceleration value and the signal indicative of occupant size; and
d) generating a signal to actuate a load limiting device for the restraint system responsive to the predicted load exceeding a threshold load value.

2. The method as recited in claim 1, including the step of determining a peak acceleration value indicative of a load exceeding the threshold load value for a plurality of occupant sizes.

3. The method as recited in claim 2, including a different peak acceleration value for each of the plurality of occupant sizes.

4. The method as recited in claim 2, including the step of determining a threshold acceleration value indicative of a load exceeding the threshold load value for the plurality of occupant sizes.

5. The method as recited in claim 4, including a different threshold acceleration value for each of the plurality of occupant sizes.

6. The method as recited in claim 4, wherein step d includes initiating the load limiting device based on one of the peak acceleration value and the threshold value exceeding a value when combined with the signal indicative of occupant size is predicted to exceed the threshold load value.

7. The method as recited in claim 1, wherein occupant size comprises a plurality of occupant size categories.

8. The method as recited in claim 1, wherein step d includes determining a time delay and generating said signal responsive to the time delay exceeding a threshold time value and the predicted load exceeding a threshold load value

9. The method as recited in claim 1, wherein the occupant size is determined utilizing a position of a seat.

10. The method as recited in claim 1, wherein the occupant size is determined utilizing a weight of the occupant.

11. The method as recited in claim 1, wherein the load limiting device is a seat belt pretension device activated to selectively release a belt restraint.

12. The method as recited in claim 1, wherein the acceleration value comprises acceleration measured in a substantially longitudinal direction.

13. A method of predicting a load on a restraint device comprising the steps of:
a) receiving a signal indicative of acceleration;
b) determining a load for a plurality of occupant categories based on the signal indicative of acceleration;
c) determining which of the plurality of occupant categories is applicable; and
d) generating a signal for controlling a restraint device based on the determined load for the applicable occupant category.

14. The method as recited in claim 13, wherein step b includes determining a load for a plurality of occupant categories based on a peak acceleration value and a threshold acceleration value.

15. The method as recited in claim 14, wherein step d includes generating the signal for controlling a restraint based on one of the peak acceleration value and the threshold acceleration value exceeding a value corresponding to a threshold load value.

16. The method as recited in claim 14, wherein the peak acceleration value and threshold acceleration value are determined for a minimum time interval.

17. The method as recited in claim 13, wherein the signal indicative of acceleration comprise a signal indicative acceleration in a longitudinal direction.
